(19) United States
(12) Patent Application Publication
(10) Pub. No.: US 2026/0093769 A1
(43) Pub. Date: Apr. 2, 2026

(54) DISTRIBUTED CONSTRAINED COMBINATORIAL OPTIMIZATION LEVERAGING HYPERGRAPH NEURAL NETWORKS

(71) Applicants: The Regents of the University of California, Oakland, CA (US); Northeastern University, Boston, MA (US)

(72) Inventors: Nasimeh Heydaribeni, Sunnyvale, CA (US); Ruisi Zhang, San Diego, CA (US); Farinaz Koushanfar, San Diego, CA (US); Tina Eliassi-Rad, Boston, MA (US)

(21) Appl. No.: 19/196,207

(22) Filed: May 1, 2025

Related U.S. Application Data
(60) Provisional application No. 63/641,601, filed on May 2, 2024.

(51) Int. Cl. G06F 17/11; G06N 3/088

(52) U.S. Cl. CPC G06F 17/11; G06N 3/088

(57) ABSTRACT

A method for solving constrained combinatorial optimization task includes receiving data associated with a constrained combinatorial optimization task and optimization variables, the data including a set of constraints defined over subsets of the optimization variables. A hypergraph is constructed based on the set of constraints and optimization variables. Each node and hyperedge of the hypergraph corresponds to an optimization variable and a constraint respectively. A hypergraph neural network is initialized based on the hypergraph and trained using unsupervised learning to output a continuous assignment for each optimization variable. The training includes updating a plurality of learnable input embeddings associated with the nodes and weight parameters of the network. The continuous assignment is then mapped to a discrete assignment selected from a set of discrete values to yield a solution to the constrained combinatorial optimization task.

### CROSS-REFERENCE TO RELATED APPLICATIONS

This application claims the benefit under 35 U.S.C. § 119 of U.S. Patent Application No. 63/641,601 filed on May 2, 2024, entitled “DISTRIBUTED CONSTRAINED COMBINATORIAL OPTIMIZATION LEVERAGING HYPERGRAPH NEURAL NETWORKS” the entirety of which is hereby incorporated by reference.

### TECHNICAL FIELD

The subject matter described herein relates to machine learning.

### BACKGROUND

Combinatorial optimization involves a process of finding an optimal object from a finite set of discrete, combinatorically large possibilities. These optimization tasks are ubiquitous across a wide range of applications, including satisfiability problems (SAT), resource allocation, scheduling, etc. In many practical applications, these tasks are subject to complex constraints that must be satisfied in order for a solution to be considered valid or feasible. Frequently, these constraints exhibit higher-order interactions, meaning that constraints may involve simultaneous dependencies among multiple variables. The solution space for these tasks is hence exponential in size, and exhaustive enumeration is impractical.

More recently, advances in machine learning have prompted exploration into data-driven methods for combinatorial optimization. An approach to integrate artificial intelligence (AI) into scientific discovery involves leveraging machine learning (ML) methods to expedite and improve the combinatorial optimization techniques to solve extremely challenging optimization tasks. In parallel, the use of graph neural networks (GNNs) has shown promise in modeling combinatorial optimization tasks by learning representations of problem instances. However, several combinatorial optimization tasks are proved to be NP-hard, rendering most existing solves non-scalable.

Moreover, existing ML-based approaches often rely on supervised learning and require ground-truth solutions for training, which are unavailable or prohibitively expensive to compute for large-scale combinatorial tasks. As a result, such methods do not generalize well to new problem instances or to tasks with different objective functions and constraint structures. Accordingly, there is a need for scalable, general-purpose systems and methods for solving constrained combinatorial optimization problems.

### SUMMARY

This disclosure relates to distributed constrained combinatorial optimization leveraging hypergraph neural networks.

An example implementation of the subject matter described within this disclosure is a method with the following features. Data associated with a constrained combinatorial optimization task and multiple optimization variables are received. The data includes a set of constraints. Each constraint in the set of constraints is defined over a subset of the optimization variables. A hypergraph is constructed based on the set of constraints and the optimization variables. The hypergraph includes multiple nodes and hyperedges. Each node and hyperedge in the hypergraph corresponds to an optimization variable and a constraint, respectively. A hypergraph neural network is initialized based on the hypergraph. The hypergraph neural network is trained using an unsupervised learning technique to learn weight parameters of the hypergraph neural network and input embeddings associated with the nodes of the hypergraph. The hypergraph neural network is trained to output a continuous assignment for each optimization variable. During the training, the hypergraph is distributed across multiple computing nodes. Each computing node operates on intra-hyperedges of the hypergraph while communicating with other computing nodes to exchange outputs associated with nodes participating in inter-hyperedges of the hypergraph. The corresponding continuous assignment for each optimization variable is then mapped to a discrete assignment selected from a set of discrete values to provide a solution to the constrained combinatorial optimization task.

The disclosed method can be implemented in a variety of ways. For example, within a system that includes at least one data processor and a non-transitory memory storing instructions for the processor to perform aspects of the method. Alternatively or in addition, the method can be included non-transitory computer readable memory storing the method as instructions which, when executed by at least one data processor forming part of at least one computing system, causes the at least one data processor to perform operations of the method.

Aspects of the example method, that can be combined with the example method alone or in combination with other aspects, can include the following. Initializing the hypergraph neural network includes following steps. Multiple layers, including an input layer, one or more hidden layers, and an output layer are initialized. Each layer is configured to perform a hypergraph convolution operation. At each hidden layer, network activations corresponding to the nodes of the hypergraph are computed using a network activation function.

Aspects of the example method, that can be combined with the example method alone or in combination with other aspects, can include the following. Training the hypergraph neural network includes following steps. The input embeddings and weight parameters of the hypergraph neural network are updated based on a loss function representing an objective of the constrained combinatorial optimization task. In some implementations, the loss function includes a cost term associated with an objective function of the constrained combinatorial optimization task, and a penalty term associated with one or more constraint violations based on the set of constraints. In some implementations, the loss function is minimized with respect to the input embeddings and the weight parameters using a gradient-based optimization algorithm.

Aspects of the example method, that can be combined with the example method alone or in combination with other aspects, can include the following. Mapping the corresponding continuous assignment to the discrete assignment includes following steps. For each optimization variable, a probability distribution over the set of discrete values is constructed based on the corresponding continuous assignment. The corresponding continuous assignment is then converted to the discrete assignment by sampling the probability distribution. In some implementations, a probability of selecting the discrete assignment from the set of discrete values is inversely proportional to a distance between the continuous assignment and the discrete assignment. In some implementations, the discrete assignment is further fine-tuned using a simulated annealing process. In some implementations, other heuristic optimization algorithms can also be used for adjusting the discrete assignment.

Aspects of the example method, that can be combined with the example method alone or in combination with other aspects, can include the following. The updated weight parameters of the hypergraph neural network can be reused to provide a solution to a second constrained combinatorial optimization task having a different object. The second constrained combinatorial optimization task is defined on the same hypergraph.

### BRIEF DESCRIPTION OF DRAWINGS

These and other features will be more readily understood from the following detailed description taken in conjunction with the accompanying drawings.

FIG. 1 is a flowchart of an example method that can be used with aspects of this disclosure;

FIG. 2 is an example hypergraph that can be used with aspects of this disclosure;

FIG. 3 is a schematic example of distributed hypergraph neural network training that can be performed with aspects of this disclosure;

FIG. 4 is an example algorithm implemented for the distributed hypergraph neural network training described in FIG. 3 that can be used with aspects of this disclosure;

FIG. 5 is an example algorithm implemented for training the hypergraph neural network in parallel that can be used with aspects of this disclosure;

FIGS. 6A-D are performance evaluation charts illustrating comparative results between the method described in FIG. 1 and baseline optimization techniques on an example constrained combinatorial optimization task;

FIGS. 7A-D are performance evaluation charts illustrating comparative results between the method described in FIG. 1 and baseline optimization techniques on another example constrained combinatorial optimization task; and

FIG. 8 is a block diagram of an example computing system that can be used with aspects of this disclosure.

### DETAILED DESCRIPTION

Certain implementations will now be described to provide an overall understanding of the principles of the structure, function, manufacture, and use of the devices and methods disclosed herein. One or more examples of these implementations are illustrated in the accompanying drawings. Those skilled in the art will understand that the devices and methods specifically described herein and illustrated in the accompanying drawings are non-limiting implementations and that the scope of the present invention is defined solely by the claims. The features illustrated or described in connection with one implementation may be combined with the features of other implementations. Such modifications and variations are intended to be included within the scope of the present invention.

Further, in the present disclosure, like-named components of the implementations generally have similar features, and thus within a particular implementation each feature of each like-named component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape. Sizes and shapes of the systems and devices, and the components thereof, can depend at least on the anatomy of the subject in which the systems and devices will be used, the size and shape of components with which the systems and devices will be used, and the methods and procedures in which the systems and devices will be used.

Constrained combinatorial optimization problems arise across numerous domains in science, engineering, logistics, and computer science. These problems generally involve identifying an optimal assignment of values to a finite set of discrete optimization variables, subject to a set of constraints. Each constraint may involve interactions among two or more variables, and in many real-world scenarios, constraints exhibit higher-order relationships involving multiple variables simultaneously.

An optimization variable refers to a discrete decision variable, for example, binary values, categorical options, or integers within a bounded domain, whose value is to be determined during the optimization process. A constraint refers to a rule or condition that must be satisfied for a particular assignment of values to be considered feasible. Constraints can be represented as mathematical expressions, logic clauses, or application-specific rules involving one or more optimization variables. In some implementations, constraints are expressed in forms such as linear inequalities, Boolean expressions, application-defined resource limits, and the like.

For example, in satisfiability problems (SAT), the optimization variable correspond to Boolean values representing true or false assignment (xᵢ∈{0, 1}), and the constraints are clauses expressed in conjunctive normal form (CNF), where each clause comprises a disjunction of literals e.g., (x₁ V¬x₃∨x₇). A solution to the SAT problem must assign values to the variables such that all clauses in the formula evaluate to true. These constraints may involve multiple variables simultaneously, depending on the clause structure. The underlying task is to find a variable assignment that satisfies all constraints. It should be noted that, other combinatorial optimization problems involving discrete decision variables and higher-order constraints are also contemplated. As the number of variables and constraints increases, the size of the solution space grows exponentially, rendering exhaustive search infeasible.

Existing approaches to combinatorial optimization as described herein, such as exact solvers and heuristic methods, struggle to efficiently handle large problem instances, especially when constraints are complex and interdependent. Recent efforts have explored the use of graph neural networks (GNNs) to learn heuristics for solving these problems, but existing models are typically limited to pairwise interactions and often rely on supervised learning with access to ground-truth solutions. These limitations restrict scalability, generalization, and flexibility across varying problem domains.

Accordingly, methods, systems, and techniques for solving constrained combinatorial optimization problems using hypergraph neural networks is provided. A set of constraints associated with a constrained combinatorial optimization task and a set of discrete optimization variables is received as input. Based on this input, a hypergraph is constructed in which nodes correspond to optimization variables and hyperedges correspond to constraints. Unlike traditional graph structures, a hypergraph is a generalization of a graph in which an edge, referred to as a hyperedge, can connect more than two nodes. In contrast to the traditional graphs, where edges represent pairwise relationships, hypergraphs are capable of representing higher-order relationships by allowing each hyperedge to span an arbitrary number of nodes. This structure is advantageous because many real-world constraints naturally involve interactions among multiple variables simultaneously. By modeling the problem as a hypergraph, each constraint can be directly encoded as a hyperedge connecting the subset of variables involved in that constraint, preserving the native structure of the problem.

A hypergraph neural network is then initialized using the constructed hypergraph and trained to generate continuous assignments for the variables. The hypergraph neural network is trained using unsupervised learning. Unsupervised learning does not require labeled data. Unsupervised learning offer several advantages over supervised learning, including enhanced generalizability and eliminating the need for datasets containing solved problem instances, which can be challenging to acquire. The trained continuous assignments are then mapped to discrete values from a predefined set to yield a feasible solution to the constrained combinatorial optimization task.

Additionally, the methods and systems described herein also supports distributed training, allowing the hypergraph neural network to be trained across multiple computing nodes by partitioning the hypergraph and coordinating updates for constraints that span across partitions (subgraphs). Further, once trained, the hypergraph neural network can be reused across different optimization tasks on the same hypergraph, enabling transfer learning without retraining the entire model. Collectively, these features allow for scalable, general-purpose, and constraint-aware optimization in domains where existing solvers are insufficient.

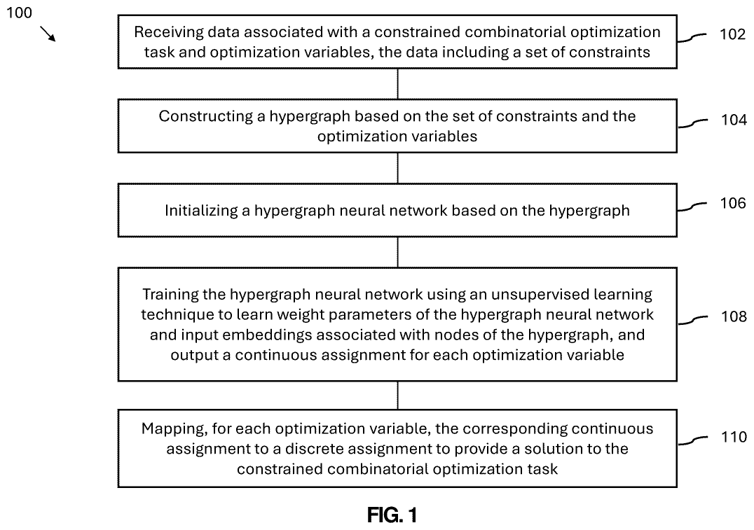

FIG. 1 is a flow chart of an example method 100 that can be used with aspect of this disclosure. At 102, data associated with a constrained combinatorial optimization task and multiple optimization variables are received. The data includes a set of constraints. Each constraint in the set of constraints is defined over a subset of the optimization variables. The constrained combinatorial optimization task may be defined as the problem of selecting values for a finite set of discrete optimization variables such that a given objective function is minimized or maximized while satisfying a set of constraints.

For instance, considering a constrained combinatorial optimization task (1) over xᵢ, i∈ [symbol] , wherein [symbol] ={1, . . . , N} represents a set of optimization variable indices. The optimization variable xᵢ are integers belonging to the set {d₀, . . . , dᵥ}, where d₀, . . . , dᵥ are some given integers and dᵢ<dⱼ for i<j. It should be understood that the optimization variables can be a combination of real and integer variables. The constrained combinatorial optimization task includes a set of constraint (functions) cₖ( [symbol] ), k∈ [symbol] , where [symbol] ={1 . . . , K} is the set of constraint indices, [symbol] ={xᵢ, i∈ [symbol] ₖ}, [symbol] ₖ⊂ [symbol] . Accordingly, such constrained combinatorial optimization task (1) can be expressed as:

$${min}_{{x}_{i} , i ∈ 𝒩} f ( x ) \qquad ( 1 a )$$

$$s . t . {c}_{k} ( {x}_{{𝒩}_{k}} ) \leq 0 , for k ∈ 𝒦 \qquad ( 1 b )$$

$${x}_{i} ∈ \{ {d}_{0} , … , {d}_{v} \} , for i ∈ 𝒩 \qquad ( 1 c )$$

each constraint (1b) may involve a subset of the optimization variables exhibit higher-order dependencies. In addition, objective (1a) and constraint functions (1b) can be non-convex and non-linear. Thus, solving the constrained combinatorial optimization task (1) can be challenging, potentially falling into the category of NP-hard problems.

In order to preserve and exploit the structure of the constraints—it is advantageous to represent the constrained combinatorial optimization task as a hypergraph having multiple nodes (vertices) and hyperedges. As shown in FIG. 1, at 104, a hypergraph is constructed based on the set of constraints and the optimization variables. A hypergraph is a generalization of a graph in which a hyperedge can connect two or more nodes simultaneously. Each node and hyperedge in the hypergraph corresponds to an optimization variable and a constraint, respectively. For instance, a hyperedge represent a constraint function defined over a subset of the optimization variable.

In some implementations, the hypergraph is constructed such that each node is associated with an input embedding representing the current state or initialization of the corresponding optimization variable. In some implementations, each hyperedge is associated with metadata or a representation of the corresponding constraint function, such as a symbolic encoding, Boolean logic expression, or differentiable constraint model. In some implementations, the hypergraph is constructed programmatically by parsing the set of constraints and identifying the subset of optimization variables involved in each constraint. In some implementations, the hypergraph is stored as a data structure comprising an adjacency representation or an incidence matrix. In some implementations, the hypergraph can be retrieved from an external data source or data repository such as a database.

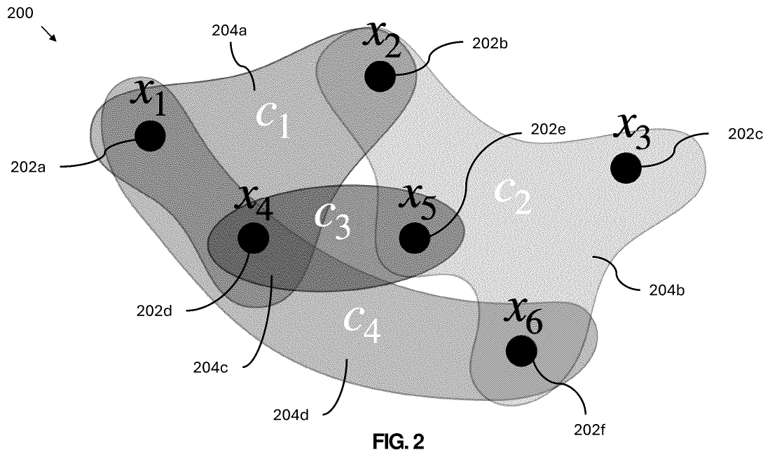

FIG. 2 is an example hypergraph 200 that can be used in this disclosure. As illustrated, the hypergraph 200 includes multiple nodes 202a-f, each corresponding to a respective optimization variable x₁ through x₆, and hyperedges 204a-d, each corresponding to a respective constraint c₁ through c₄. When constructing the hypergraph 200, a hyperedge including nodes [symbol] is formed for each constraint cₖ( [symbol] ). For example, hyperedge 204a (c₁) connects nodes 202a, 202b, 202d (x₁, x₂, x₄), indicating that the associated constraint function c₁(x₁, x₂, x₃) involves those optimization variables. Similarly, hyperedge 204b (c₂) connects nodes 202b, 202c (x₂, x₃); hyperedge 204c (c₃) connects nodes 202d, 202e (x₄, x₅); and hyperedge 204d (c₄) spans nodes 202a, 202d, 202f (x₁, x₄, x₆). As shown in FIG. 2, rather than approximating each constraint with pairwise edges, hypergraph 200 preserves the exact dependency structure of the given constraint set {c₁, c₂, c₃, c₄}, enabling more expressive message passing and representation learning when used in conjunction with learnable transformation function as described herein.

As indicated above, the constrained combinational optimization task involves discrete optimization variables and potentially non-convex, non-linear objective and constraint functions. It is impractical to apply gradient-based optimization methods directly to the original constrained combinatorial optimization task (1) since the solution space is discontinuous and highly non-smooth. Accordingly, to enable gradient-based training and facilitate scalable optimization, the constrained combinatorial optimization task (1) is relaxed into a continuous domain. For instance, the relaxed version (2) of the constrained combinatorial optimization task (1) is given below:

$${min}_{{p}_{i} , i ∈ 𝒩} f ( p ) \qquad ( 2 a )$$

$$s . t . {c}_{k} ( {p}_{{𝒩}_{k}} ) \leq 0 , for k ∈ 𝒦 \qquad ( 2 b )$$

$${p}_{i} ∈ \{ {d}_{0} , {d}_{v} \} , for i ∈ 𝒩 \qquad ( 2 c )$$

Where pᵢ represents the continuous (relaxed) form of xᵢ, and it is within the continuous interval [d₀, dᵥ]. While relaxing the optimization task may not guarantee globally optimal solution due to the relaxation and potential convergence to suboptimal local optima, it remains a prevalent practice due to the availability and efficiency of the gradient descent-based solvers, such as ADAM.

It should be noted that one can solve the constrained combinatorial optimization task (2) directly using gradient descent-based methods and then map the continuous outcomes to discrete values using, for example, penalty-based method to ensure the constraints are satisfied in the final outcome, however, a better solution i.e., a solution associated with lower objective value or better cost and/or fewer constraint violations) can be achieved by solving an alternative constrained combinatorial optimization task (3) as described in further detail below. The optimization variables pᵢ associated with the alterative constrained combinational optimization task (3) are the outcomes of a transformation function based on hypergraph neural networks. Such transformation function is utilized with the goal of capturing the intricate patterns and interdependence of the variables through the problem constraints and therefore, obtaining solutions that are more closely approximate the global minimum of the original combinatorial optimization objective.

One skilled in art, upon reviewing the entirety of this disclosure, will recognize various transformation functions can be utilized in order to render the constrained combinatorial optimization task (2) tractable, such as linear approximation, logarithmic transformations, convex envelops, piecewise quadratic functions, and the like; however, it should be understood that these listed transformation functions are fixed function.

A parameterized transformation function can be provided based on a hypergraph neural network. Now returning to FIG. 1, at step 106, a hypergraph neural network can be initialized based on the constructed hypergraph. A hypergraph neural network is a neural architecture that operates over hypergraphs, allowing iterative message passing between nodes and hyperedges to learn representations that capture complex, higher-order dependencies encoded by the constraints. For example, each node aggregates information from other nodes that participate in the same constraint via shared hyperedges, enabling the network to learn representations that reflect both the local and global structure of the constrained combinatorial optimization task.

In some implementations, when initializing the hypergraph neural network, multiple layers, including an input layer, one or more hidden layers, and an output layer are initialized. Each layer is configured to perform a hypergraph convolution operation (see equation 6 below). The hypergraph convolution operation is a message-passing mechanism adapted for hypergraphs in which information is aggregated from the nodes to the hyperedges and from the hyperedges back to the nodes. Typically, a node sends its current embedding to each connected hyperedge. Each hyperedge aggregates the embeddings of its incident nodes, for example, using a permutation-invariant function such as mean, sum, or attention-weighted combination and sends a transformed message back to each participating node.

In some implementations, during initialization, each node in the hypergraph is associated with a corresponding input embedding, which may be initialized randomly, for example, using heuristic-based priors or via pretraining. These input embeddings are learnable, real-valued vectors that represent the initial state of the respective optimization variables in a continuous latent space. Over the source of training (the hypergraph neural network), these input embeddings can be iteratively updated through the hypergraph convolution operations. In some instances, these input embeddings capture information about the role of each optimization variable in the constrained combinatorial optimization task. For example, in a resource allocation task, a node corresponding to an optimization variable that represents a specific agent may be initialized with an embedding vector that reflects the agent's capacity.

The input layer of the hypergraph neural network can process the initial embeddings and forward them to subsequent layers. Each hidden layer applies the hypergraph convolution operation that aggregates information across the hypergraph structure. Specifically, for each node, the hidden layer receives messages from the hyperedges to which it belongs, and each hyperedge, in turn, aggregates messages from the nodes it connects. In some implementations, each aggregation step is followed by an application of a network activation function, for example, a non-linear activation function such as ReLU, sigmoid, or softmax and, optionally, normalization techniques such as batch normalization or layer normalization. The output layer of the hypergraph neural network can produce a continuous-valued vector or scalar for each node, representing a relaxed assignment for the corresponding optimization variable.

Accordingly, by adopting the parameterized transformation function, the constrained combinatorial optimization task (2) can be reformulated to the following:

$${min}_{σ , W} f ( 𝒢 ( σ , W ) ) \qquad ( 3 a )$$

$$s . t . {c}_{k} ( {𝒢}_{{𝒩}_{k}} ( σ ; W ) ) \leq 0 , for k ∈ 𝒦 \qquad ( 3 b )$$

$${𝒢}_{i} ( σ ; W ) ∈ [ {d}_{0} , {d}_{v} ] , for i ∈ 𝒩 \qquad ( 3 c )$$

Where p= [symbol] (σ, W) (or pᵢ= [symbol] ᵢ (σ; W) for i∈ [symbol] ), W is the parameter vector (i.e., weight parameters) of the hypergraph neural network (or hypergraph-based transformation function) [symbol] , and σ=[σ₁, σ₂, . . . , σ_{N}] is the set of input embeddings (e.g., σᵢ is node i's input embedding).

At 108, the hypergraph neural network is trained using an unsupervised learning technique to learn weight parameters W of the hypergraph neural network [symbol] and input embeddings σ associated with the nodes of the hypergraph. As indicated above, the hypergraph neural network [symbol] is trained to output a continuous assignment (pᵢ) for each optimization variable. It should be understood that the methods and systems as described herein can be conceptualized as a fusion of gradient descent-based optimization techniques with ML-based transformation functions. In particular, the optimization variables are computed through the hypergraph neural network [symbol] , and the objective function is optimized by applying gradient descent over the weight parameters W of the hypergraph neural network [symbol] . This establishes more efficient optimization paths compared to conventional direct gradient descent which can become trapped in subpar local optima.

In some implementations, when training the hypergraph neural network, the hypergraph neural network is defined on the hypergraph with a loss function includes a cost term associated with an objective function of the constrained combinatorial optimization task, and a penalty term associated with one or mor constraint violations. Specifically, the loss function can be expressed as:

$$\hat{f} ( p ) = f ( p ) + {\sum }_{k ∈ 𝒦} {{λ}_{k} ( {c}_{k} ( {p}_{{𝒩}_{k}} ) )}^{+} \qquad ( 4 )$$

where (a)⁺=max (0, a), and λₖ is the weight of constraint k. In some implementations, the loss function the loss function is minimized with respect to the input embeddings and the weight parameters using a gradient-based optimization algorithm, such as gradient decent, stochastic gradient descent, and Adam. Additionally, the hypergraph convolution operation can be defined as:

$${H}^{( l + 1 )} = σ ( {D}_{v}^{- \frac{1}{2}} \tilde{M} {D}_{v}^{- \frac{1}{2}} {H}^{( l )} {W}^{( l )} ) \qquad ( 5 )$$

$$where :$$

$$\tilde{M} = A {\tilde{D}}_{e}^{- 1} {A}^{T} - diag ( A {\tilde{D}}_{e}^{- 1} {A}^{T} ) \qquad ( 6 )$$

and H^{(l)}∈ [symbol] ^{N×D} is the matrix of node features at l^{th} hidden layer, A is the hypergraph incidence matrix defined as (A)ᵢⱼ=1 if node i belongs to hyperedge j, and (A)ᵢⱼ=0 otherwise. Dᵥ and Dₑ are the diagonal degree matrices of nodes and hyperedges, respectively, and \tilde{D}ₑ=Dₑ−I. W^{(l)} is the l^{th} hidden layer trainable weight matrix.

In some implementations, the hypergraph can be distributed across multiple computing nodes for distributed training. For example, the hypergraph can be partitioned into a number of subgraphs between servers or GPUs beforehand to expedite the training process and handle large-scale constrained combinatorial optimization task effectively. In this setup, each computing node maintains a local view of the hypergraph. In other words, each computing node can have access to at least a subgraph of the original hypergraph. Accordingly, the training of hypergraph neural network takes place collaboratively among these computing nodes.

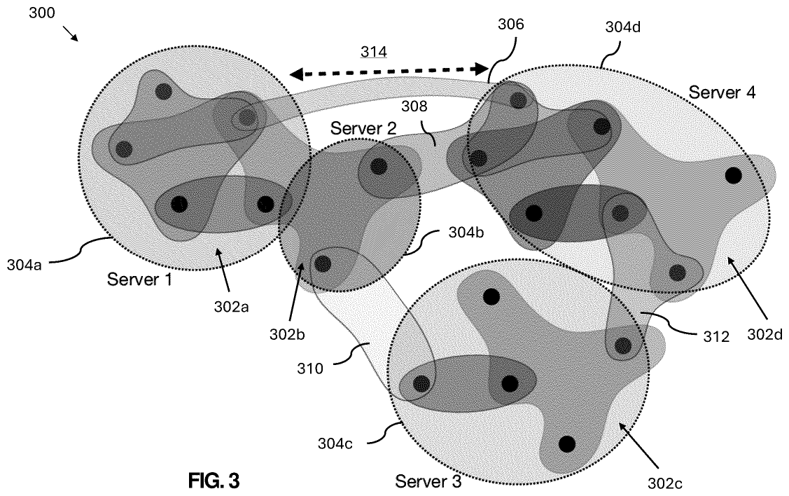

FIG. 3 illustrated a schematic example of distributed hypergraph neural network training. In this example, the hypergraph 300 is partitioned into multiple subgraphs 302a-d across multiple servers 304a-d. Each server is configured to operate on a respective subgraph having a local group of nodes (representing a subset of optimization variables) and associated intra-hyperedges. Intra-hyperedges represent constraints that are defined entirely over the local group of nodes. In some implementations, the partitioning is structured such that each server can perform local message passing and parameter updates independently for intra-hyperedges.

As illustrated in FIG. 3, some hyperedges (e.g., 306, 308, 310, and 312) span multiple servers—these hyperedges are referred to as inter-hyperedges. In these cases, the participating servers can communicate with other servers to exchange intermediate model information (314). For example, input embeddings associated with nodes or gradient contributions from other subgraphs can be exchanged as part of the forward and backward passes. It should be noted that this coordination between servers is bidirectional, meaning that each server both sends and receives model updates associated with shared inter-hyperedges.

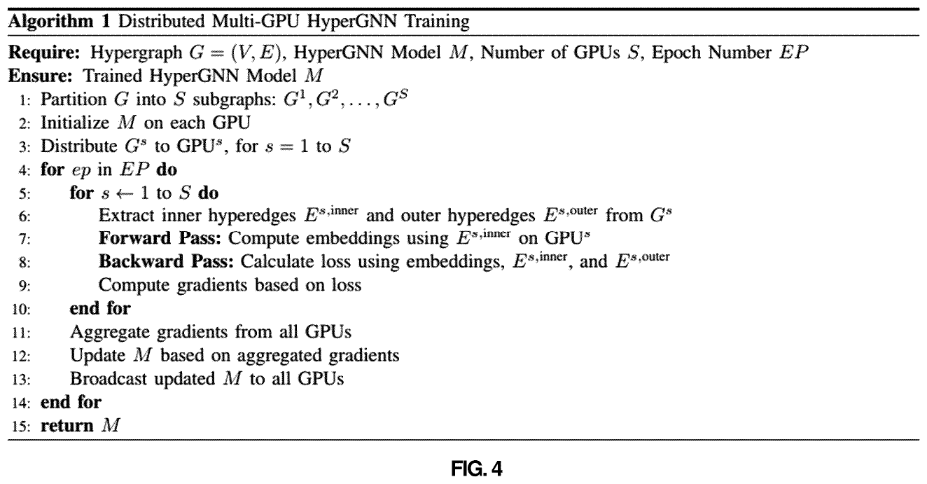

In particular, the distributed training can be implemented as outlined by algorithm 400 as illustrated in FIG. 4. For example, given a hypergraph G=(V, E), and S GPUs to train the hypergraph neural network M, the hypergraph G is partitioned into S subgraphs. The subgraph G^{S}=(V^{S}, E^{S,inner}, E^{S,outer}) includes nodes V^{S} in G^{S}, intra-hyperedges E^{S,inner} connecting nodes V^{S} within subgraphs G^{S}, and inter-hyperedges E^{S,outer} linking nodes V^{S} to other subgraphs. During the forward pass, each GPU computes local node embeddings using E^{S,inner}, and during the backward pass, the GPU calculates the loss with both local node embeddings and node embeddings connected by E^{S,outer} to update weight parameters M^{S} of the hypergraph neural network M. Subsequently, the gradients of each M^{S} are aggregated and disseminated to all GPUs.

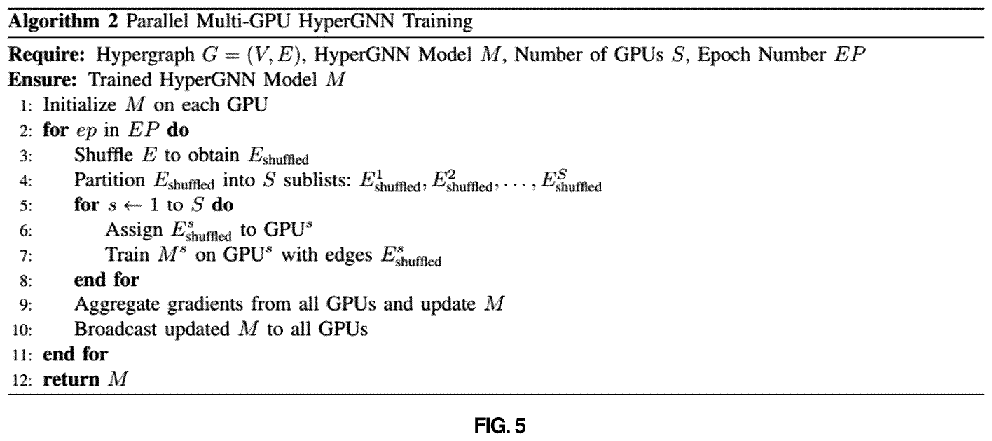

Similarly, parallel training of hypergraph neural network using multiple computing nodes to accelerate the training and enable model operation on large-scale constrained combinatorial optimization task are also contemplated herein. FIG. 5 illustrate an example algorithm 500 implemented for training the hypergraph neural network M in parallel. The hypergraph neural network M is initialized on each GPU, and in each epoch, the hypergraph G's hyperedge information E are randomly partitioned into S parts. Each GPU receives its corresponding hyperedges E^{S} and trains M^{S} simultaneously. The gradients are then aggregated and disseminated to all GPUs. Both distributed training and parallel training of the hypergraph neural network may be employed to improve scalability and training efficiency.

Referring back to FIG. 1, at 110, the corresponding continuous assignment pᵢ i.e., the continuous outputs generated through Hypergraph neural network for each optimization variable is then mapped to a discrete assignment xᵢ selected from a set of discrete values {d₀, . . . , dᵥ} to provide a solution to the constrained combinatorial optimization task (1), (2), or (3). In some implementations, for each optimization variable, a probability distribution over the set of discrete values is constructed based on the corresponding continuous assignment. The corresponding continuous assignment is then converted to the discrete assignment by sampling the probability distribution. A probability of selecting the discrete assignment from the set of discrete values is inversely proportional to a distance between the continuous assignment and the discrete assignment. For example, for the binary case of 0 and 1, the output will be probability of 1. The mapping then proceeded as follows. A sample is taken from x₁, . . . , x_{N} from the output distribution corresponding to p₁, . . . , p_{PN}, Subsequently, a simulated annealing process is performed with the sample, minimizing the loss function (4).

During the simulated annealing process, small perturbations can be made to the current discrete assignment, such as flipping the value of the discrete assignment or swapping two discrete assignments and resulting change in the loss function (4) is evaluated. For instance, if the new discrete assignment yields a lower loss, it is accepted. If the loss increases, the new assignment may still be accepted with a probability determined by a temperature parameter T, which gradually decreases over time. Specifically, worse solutions are accepted with probability proportional to exp (−ΔL/T), where ΔL is the increase in the loss function. As T decreases, the algorithm becomes more selective, converging toward a locally optimal solution. The simulated annealing process is repeated for a given number of times. The best outcome is chosen as the final solution.

Alternatively or in addition, the methods and systems can be used to address various constrained combinatorial optimization tasks on a single hypergraph. In some implementations, the hypergraph neural network is pre-trained on a first constrained combinatorial optimization task and then the pre-trained hypergraph neural network is utilized for a second constrained combinatorial optimization task having a different objective (e.g., a new objective function) but defined on top of the same set of constraints. The updated weight parameters of the pre-trained hypergraph neural network can be reused to provide a solution to the second constrained combinatorial optimization task exclusively. In particular, the weight parameters W are frozen and only the input embeddings σ associated with the nodes are updated. It should be understood that the hypergraph neural network learns an effective function to capture graph features modeled by [symbol] (σ, W) and therefore, it can potentially be used for other types of optimization tasks on the same graph. For example, the hypergraph neural network can be trained for MaxCut problem and transferred to address the Maximum Independent Set (MIS) problem without re-initializing or retraining the hypergraph neural network from scratch (e.g., vanilla training).

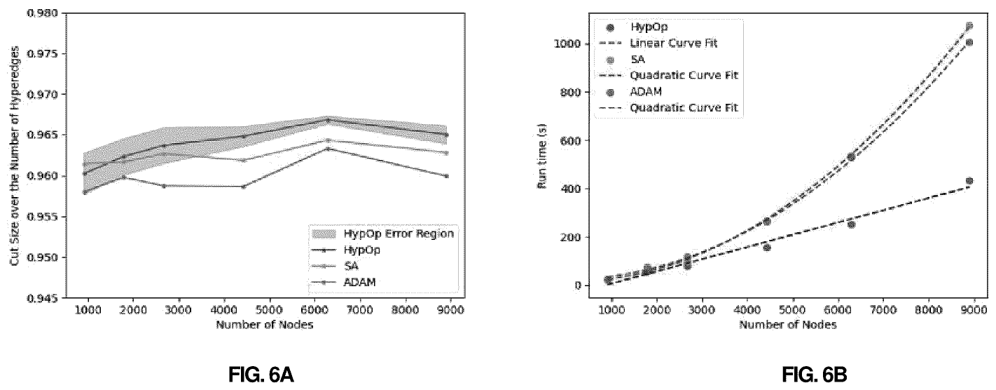

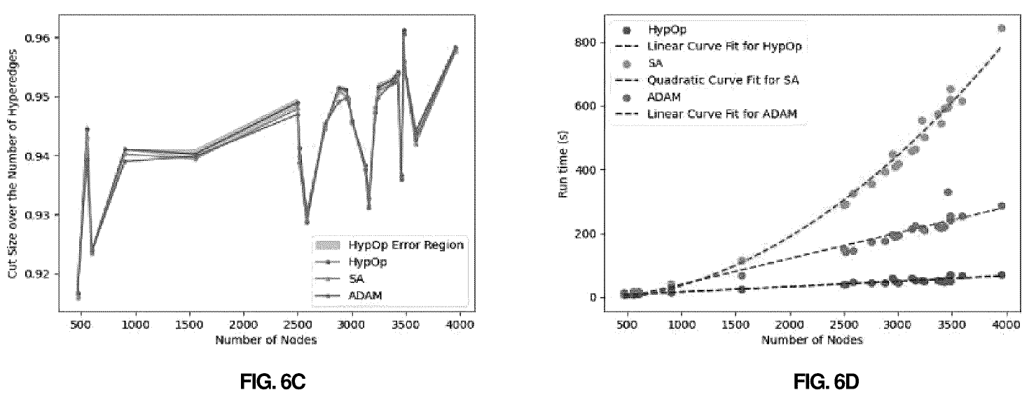

FIGS. 6A-D illustrate the performance of the disclosed method (labeled as HypOp) compared to baseline solvers, such as simulated annealing (SA) and direct gradient descent (ADAM) on a constrained combinatorial optimization task such as MaxCut using both synthetic hypergraph (FIGS. 6A-B) and real hypergraph (FIGS. 6C-D). The real hypergraph are extracted from the American Physical Society (APS). In MaxCut, the goal is to partition the nodes of a hypergraph into two groups such that the cut size is maximized, where the cut size is the number of hyperedges that have at least one pair of nodes belonging to different groups. As shown in FIGS. 6A-D, with almost the same performance, the runtime of HypOp is significantly less than the other two methods. Notably, the runtime of HypOp grows linearly with the number of nodes, while the runtime of SA grows quadratically.

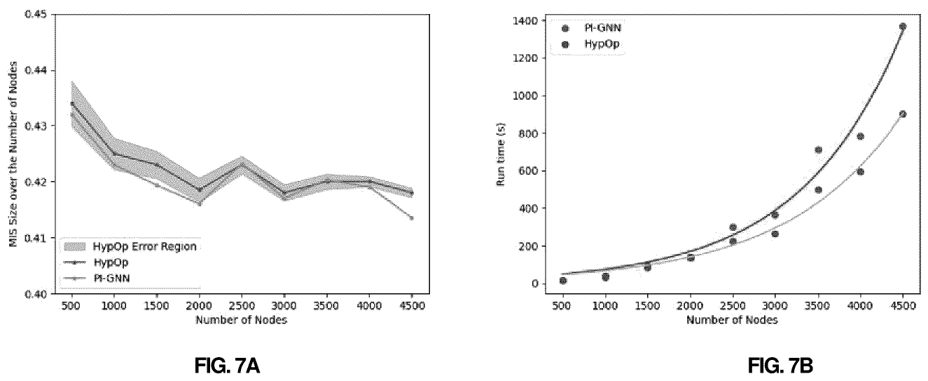

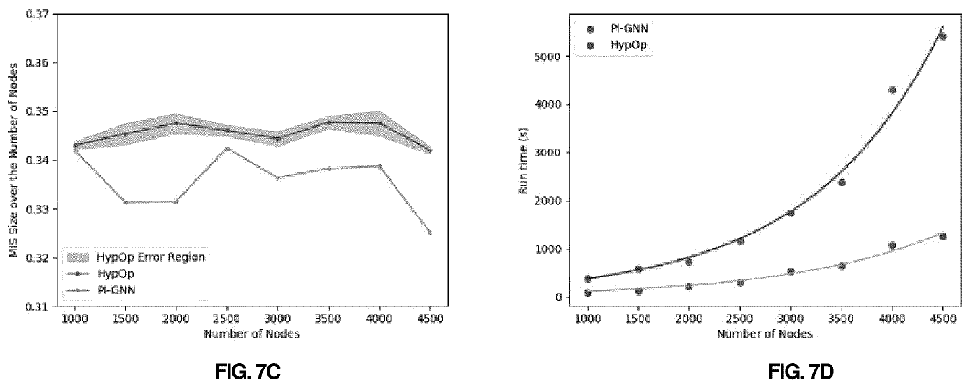

In addition, as illustrate in FIGS. 7A-D, the performance of HypOp is also compared with PI-GNN using both synthetic hypergraph (FIGS. 7A-B) and real hypergraph (FIGS. 7C-D). In MIS, the objective is to identify the largest possible subset of nodes in the hypergraph such that no hyperedge contains more than one node from the subset. The performance and runtime of PI-GNN and HypOP over regular random graphs with d=3 and d=5 are shown in FIGS. 7A-D. HypOp achieves better results than PI-GNN in a less amount of time. The error region shows the standard deviation of the final results over 10 sets of experiments. The runtime standard deviations were significant, with an average of 10 s.

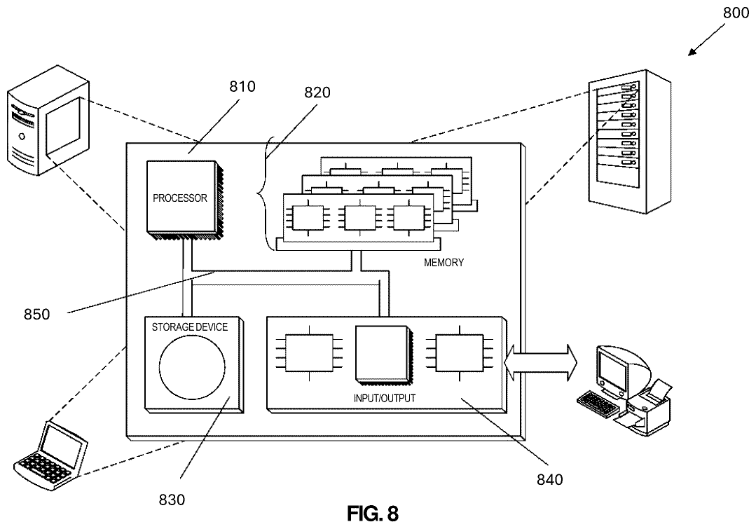

The methods described herein can be implemented by one or more computing systems. FIG. 8 illustrates a schematic diagram of an example computing system 800 is provided. The example computing system 800 includes a processor 810, a memory 820, a storage device 830, and an input/output device 840. The components 810, 820, 830, 840 are interconnected using a system bus 850. The processor 810 is capable of processing instructions for execution within the example computing system 800. In one implementation, the processor 810 is a single-threaded processor. In another implementation, the processor 810 is a multi-threaded processor. The processor 810 is capable of processing instructions stored in the memory 820 or on the storage device 830 to display graphical information for a user interface on the input/output device 840.

The memory 820 stores information within the example computing system 800. In one implementation, the memory 820 is a computer-readable medium. In one implementation, the memory 820 is a volatile memory unit. In another implementation, the memory 820 is a nonvolatile memory unit. The storage device 830 is capable of providing mass storage for the example computing system 800. In one implementation, the storage device 830 is a computer-readable medium. In various different implementations, the storage device 830 can be a floppy disk device, a hard disk device, an optical disk device, or a tape device. The input/output device 840 provides input/output operations for the example computing system 800. In one implementation, the input/output device 840 includes a keyboard and/or pointing device. In another implementation, the input/output device 840 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. The computer program can be written in any form of programming language, including compiled or interpreted languages, and it can be deployed in any form, including as a stand-alone program or as a module, component, subroutine, or other unit suitable for use in a computing environment.

As used herein, the term “module” refers to computing software, firmware, hardware, and/or various combinations thereof. At a minimum, however, modules are not to be interpreted as software that is not implemented on hardware, firmware, or recorded on a non-transitory processor readable recordable storage medium (i.e., modules are not software per se). Indeed “module” is to be interpreted to always include at least some physical, non-transitory hardware such as a part of a processor or computer. Two different modules can share the same physical hardware (e.g., two different modules can use the same processor and network interface). The modules described herein can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices.

Suitable processors for the execution of a program of instructions include, by way of example, both general and special purpose microprocessors, and the sole processor or one of multiple processors of any kind of computer. Generally, a processor will receive instructions and data from a read-only memory or a random-access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps can be provided, or steps can be eliminated, from the described flows, and other components can be added to, or removed from, the described systems. Accordingly, other implementations are within the scope of the following claims.

A number of implementations of the present disclosure have been described. Nevertheless, it will be understood that various modifications can be made without departing from the spirit and scope of the present disclosure. Accordingly, other implementations are within the scope of the following claims.

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system can include clients and servers. A client and server are generally remote from each other and typically interact through a communication network. The relationship of client and server arises by virtue of computer programs running on the respective computers and having a client-server relationship to each other.

What is claimed is:

1. A method comprising:
receiving data associated with a constrained combinatorial optimization task and a plurality of optimization variables, the data including a set of constraints, wherein each constraint in the set of constraints is defined over a subset of the plurality of optimization variables;
constructing a hypergraph based on the set of constraints and the plurality of optimization variables, wherein the hypergraph comprises a plurality of nodes and a plurality of hyperedges connecting the plurality of nodes, wherein each node corresponds to an optimization variable, and wherein each hyperedge corresponds to a constraint;
initializing a hypergraph neural network based on the hypergraph;
training the hypergraph neural network using an unsupervised learning technique to learn weight parameters of the hypergraph neural network and a plurality of input embeddings associated with the plurality of nodes, and output a continuous assignment for each optimization variable of the plurality of optimization variables, wherein the training comprises:
distributing the hypergraph across a plurality of computing nodes, each computing node operates on intra-hyperedges of the hypergraph while communicating with other computing nodes to exchange outputs associated with nodes participating in inter-hyperedges of the hypergraph; and
mapping, for each optimization variable of the plurality of optimization variables, the corresponding continuous assignment to a discrete assignment selected from a set of discrete values to provide a solution to the constrained combinatorial optimization task.

2. The method of claim 1, wherein the initializing comprises:
initializing a plurality of layers, the plurality of layers having an input layer, one or more hidden layers, and an output layer, each layer of the plurality of layers is configured to perform a hypergraph convolution operation; and
computing, at each hidden layer of the plurality of hidden layers, a plurality of network activations corresponding to the plurality of nodes using a network activation function.

3. The method of claim 1, wherein the training comprises:
updating the plurality of input embeddings and the weight parameters of the hypergraph neural network based on a loss function representing an objective of the constrained combinatorial optimization task.

4. The method of claim 3, wherein the loss function comprises a cost term associated with an objective function of the constrained combinatorial optimization task, and a penalty term associated with one or more constraint violations based on the set of constraints.

5. The method of claim 4, wherein the updating comprises:
minimizing the loss function with respect to the plurality of input embeddings and the weight parameters using a gradient-based optimization algorithm.

6. The method of claim 1, wherein the mapping comprises:
constructing, for each optimization variable of the plurality of optimization variables, a probability distribution over the set of discrete values based on the corresponding continuous assignment; and
converting the continuous assignment to the discrete assignment by sampling the probability distribution.

7. The method of claim 6, wherein a probability of selecting the discrete assignment from the set of discrete values is inversely proportional to a distance between the continuous assignment and the discrete assignment.

8. The method of claim 1, wherein the mapping further comprises adjusting the discrete assignment using a simulated annealing process.

9. The method of claim 1, wherein the mapping further comprises adjusting the discrete assignment using a gradient-based optimization algorithm.

10. The method of claim 3, further comprising:
reusing the updated weight parameters of the hypergraph neural network to provide a solution to a second constrained combinatorial optimization task having a different objective, wherein the second constrained combinatorial optimization task is defined on a same hypergraph.

11. A system comprising:
at least one processor; and
at least one memory storing instructions, which, when executed by the at least one processor causes operations comprising:
receiving data associated with a constrained combinatorial optimization task and a plurality of optimization variables, the data including a set of constraints, wherein each constraint in the set of constraints is defined over a subset of the plurality of optimization variables;
constructing a hypergraph based on the set of constraints and the plurality of optimization variables, wherein the hypergraph comprises a plurality of nodes and a plurality of hyperedges connecting the plurality of nodes, wherein each node corresponds to an optimization variable, and wherein each hyperedge corresponds to a constraint;
initializing a hypergraph neural network based on the hypergraph;
training the hypergraph neural network using an unsupervised learning technique to learn weight parameters of the hypergraph neural network and a plurality of input embeddings associated with the plurality of nodes, and output a continuous assignment for each optimization variable of the plurality of optimization variables, wherein the training comprises:
distributing the hypergraph across a plurality of computing nodes, each computing node operates on intra-hyperedges of the hypergraph while communicating with other computing nodes to exchange outputs associated with nodes participating in inter-hyperedges of the hypergraph; and
mapping, for each optimization variable of the plurality of optimization variables, the corresponding continuous assignment to a discrete assignment selected from a set of discrete values to provide a solution to the constrained combinatorial optimization task.

12. The system of claim 11, wherein the initializing comprises:
initializing a plurality of layers, the plurality of layers having an input layer, one or more hidden layers, and an output layer, each layer of the plurality of layers is configured to perform a hypergraph convolution operation; and
computing, at each hidden layer of the plurality of hidden layers, a plurality of network activations corresponding to the plurality of nodes using a network activation function.

13. The system of claim 11, wherein the training comprises:
updating the plurality of input embeddings and the weight parameters of the hypergraph neural network based on a loss function representing an objective of the constrained combinatorial optimization task.

14. The system of claim 13, wherein the loss function comprises a cost term associated with an objective function of the constrained combinatorial optimization task, and a penalty term associated with one or more constraint violations based on the set of constraints, wherein the updating comprises:
minimizing the loss function with respect to the plurality of input embeddings and the weight parameters using a gradient-based optimization algorithm.

15. The system of claim 11, wherein the mapping comprises:
constructing, for each optimization variable of the plurality of optimization variables, a probability distribution over the set of discrete values based on the corresponding continuous assignment; and
converting the continuous assignment to the discrete assignment by sampling the probability distribution.

16. The system of claim 15, wherein a probability of selecting the discrete assignment from the set of discrete values is inversely proportional to a distance between the continuous assignment and the discrete assignment.

17. The system of claim 11, wherein the mapping further comprises adjusting the discrete assignment using a simulated annealing process.

18. The system of claim 11, wherein the mapping further comprises adjusting the discrete assignment using a gradient-based optimization algorithm.

19. The system of claim 13, further comprising:
reusing the updated weight parameters of the hypergraph neural network to provide a solution to a second constrained combinatorial optimization task having a different objective, wherein the second constrained combinatorial optimization task is defined on a same hypergraph.

20. A non-transitory computer readable memory storing instructions which, when executed by at least one processor causes operations comprising:
receiving data associated with a constrained combinatorial optimization task and a plurality of optimization variables, the data including a set of constraints, wherein each constraint in the set of constraints is defined over a subset of the plurality of optimization variables;
constructing a hypergraph based on the set of constraints and the plurality of optimization variables, wherein the hypergraph comprises a plurality of nodes and a plurality of hyperedges connecting the plurality of nodes, wherein each node corresponds to an optimization variable, and wherein each hyperedge corresponds to a constraint;
initializing a hypergraph neural network based on the hypergraph;
training the hypergraph neural network using an unsupervised learning technique to learn weight parameters of the hypergraph neural network and a plurality of input embeddings associated with the plurality of nodes, and output a continuous assignment for each optimization variable of the plurality of optimization variables, wherein the training comprises:
distributing the hypergraph across a plurality of computing nodes, each computing node operates on intra-hyperedges of the hypergraph while communicating with other computing nodes to exchange outputs associated with nodes participating in inter-hyperedges of the hypergraph; and
mapping, for each optimization variable of the plurality of optimization variables, the corresponding continuous assignment to a discrete assignment selected from a set of discrete values to provide a solution to the constrained combinatorial optimization task.
